(19) United States
(12) Patent Application Publication
(10) Pub. No.: US 2025/0092178 A1
(43) Pub. Date: Mar. 20, 2025

(54) IMIDE FUNCTIONAL ORGANOPOLYSILOXANES

(71) Applicant: MOMENTIVE PERFORMANCE MATERIALS INC., Niskayuna, NY (US)

(72) Inventors: Banpreet Kaur, Bangalore (IN); Yoichiro Ijima, Kanagawa (JP); Karthikeyan Sivasubramanian, Bangalore (IN); Motoshi Sasaki, Gunma (JP); Monjit Phukan, West Harrison, NY (US); Naoya Fujiwara, Gunma (IN); Kyohei Mochizuki, Kanagawa (JP)

(21) Appl. No.: 18/889,768

(22) Filed: Sep. 19, 2024

(30) Foreign Application Priority Data
Sep. 19, 2023 (IN) 202311062907

(51) Int. Cl. C08F 290/06

(52) U.S. Cl. CPC C08F 290/068

(57) ABSTRACT

An imide functional organopolysiloxane is shown and described herein. The imide functional organopolysiloxane comprises multiple functional groups and, in embodiments, at least comprises an imide functional group and an epoxy functional group. Also provided are composite materials comprising the imide functional organopolysiloxane.

### CROSS REFERENCE TO RELATED APPLICATIONS

The present application claims priority to and the benefit of India Provisional Application 202311062907 filed on Sep. 19, 2023, the disclosure of which is incorporated herein by reference in its entirety.

### FIELD OF INVENTION

The present invention relates to an imide functional organopolysiloxane. In particular, the present invention relates to an imide functional organopolysiloxane modified with imide and/or epoxy functional groups.

### BACKGROUND

Silicone materials are used in a variety of applications. Silicone materials exhibit a wide array of properties that may make them suitable for particular applications. They can be used, for example as additives to impart particular properties to a polymer system. For example, silicone materials can provide a composition with flexibility, thermal stability, strength, optical clarity, and the like. Not all silicone materials, however, achieve the same effect and are suitable for all applications. In particular it is challenging to have silicone materials having combination of attributes such as high curability, low thermal expansion and high thermal stability. There is a need for silicone materials with such a combination of attributes.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is an imide functional organopolysiloxane. The imide functional organopolysiloxane comprises imide functional groups and epoxy functional groups. In embodiments, the imide and/or epoxy functional groups can be pendant to a siloxane chain. In other embodiments, the imide functional organopolysiloxane can include an imide group bridging siloxane units.

Also provided is a method for preparing the imide functional organopolysiloxanes. In embodiments, the respective imide and epoxy functional groups are separately introduced into the siloxane via hydrosilylation reactions with a siloxane. In embodiments, the reaction comprises an alkenyl functional imide and a hydride functional siloxane, wherein the alkenyl functional imide reacts with the hydride functional siloxane to form an imide functional siloxane. The imide functional siloxane, bearing residual hydride functional groups, is then reacted with an alkenyl functional epoxy compound to provide the imide functional organopolysiloxane. In further embodiments, alkenyl functional aromatic or aliphatic groups may also be introduced to the imide functional organopolysiloxane by hydrosilylation.

In still another aspect, provided is a method of preparing an imide functional organopolysiloxane comprising reacting an aliphatic, an aromatic substituted dianhydride, a diamino or dianhydride functional siloxane, and an aliphatic or aromatic functional amine in a one-pot reaction.

In one aspect, provided is a siloxane comprising an imide functional group, and at least one functional group selected from an epoxy, a hydride, an aromatic, an aliphatic, an amine, and/or an acryl or acryloxy, where the siloxane is selected from a linear siloxane and a non-linear siloxane, wherein the non-linear siloxane comprises at least two of said functional groups selected from an epoxy, a hydride, an aromatic, an aliphatic, an amine, and/or an acryl or acryloxy.

In one embodiment, the siloxane is according to formula (I)

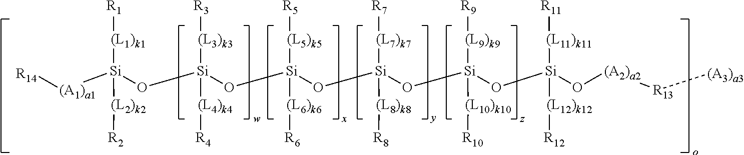

where R₁, R₂, R₃, R₄, R₅, R₆, R₇, R₈, R₉, R₁₀, R₁₁, R₁₂, R₁₃, and R₁₄ are each independently selected from hydrogen, a C1-C15 alkyl, an epoxy group, a C6-C30 aromatic containing group, and a imide group, with the provisos that (i) at least one of R¹, R², R³, R⁴, R⁵, R⁶, R⁷, R⁸, R⁹, R¹⁰, R¹¹, R¹², R¹³, and R¹⁴ is selected from an imide group, and (ii) at least one of R¹, R², R³, R⁴, R⁵, R⁶, R⁷, R⁸, R⁹, R¹⁰, R¹¹, R¹², R¹³, and R¹⁴ is selected from an epoxy group;
A₁, A₂, A₃, and L₁, L₂, L₃, L₄, L₅, L₆, L₇, L₈, L₉, L₁₀, L₁₁, and L₁₂ are linker groups each independently selected from a divalent alkyl group, a divalent alkenyl group, and a divalent ether groups;
is ≥1;
w, x, y, and z are each ≥0, where (w+x+y+z) is from 1 to 60;
k1, k2, k3, k4, k5, k6, k7, k8, k9, k10, k11, k12 are each independently ≥0; and
a1, a2, and a3 are each independently ≥0.

In one embodiment, at least one of R₁, R₂, R₃, R₄, R₅, R₆, R₇, R₈, R₉, R₁₀, R₁₁, and/or R₁₂ is selected from an imide, at least one of R₁, R₂, R₃, R₄, R₅, R₆, R₇, R₈, R₉, R₁₀, R₁₁, and/or R₁₂ is selected from an epoxy, and least one of R₁, R₂, R₃, R₄, R₅, R₆, R₇, R₈, R₉, R₁₀, R₁₁, and/or R₁₂ is selected from an C6-C30 aromatic group.

In one embodiment, R₁, R₂, R₃, R₄, R₅, R₇, R₉, R₁₀, R₁₁, and R₁₂ are independently selected from hydrogen, a C1-C15 alkyl group, and a C6-C30 aromatic, R₁₃ is selected from an imide functional group, and R₁₄ is selected from an epoxy functional group.

In one embodiment, R₁, R₂, R₃, R₄, R₅, R₆, R₇, R₈, R₉, R₁₀, R₁₁, and/or R₁₂ are each independently selected from hydrogen and a C1-C15 alkyl group, and R₁₃ and R₁₄ are selected from a substituted or non-substituted bisimide.

In one embodiment in accordance with any of the previous embodiments, the imide group is selected from a group of the formulas (IV), (V), and (VI):

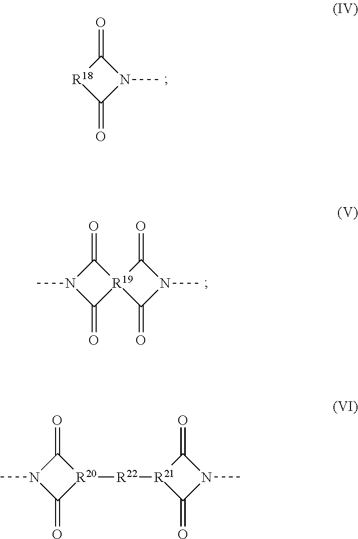

where R¹⁸, R¹⁹, R²⁰, and R²¹ are independently selected from a C2 to C30 divalent organic group, and R²² is selected from a bond, a C1-C30 divalent organic group, or an O atom.

In yet another aspect, provided is a method of forming an imide functional organopolysiloxane comprising:
(i) reacting an alkenyl functional imide with a hydride functional siloxane to produce an imide functional siloxane, where the imide functional siloxane contains unreacted hydride groups, and
(ii) reacting the imide functional siloxane having the unreacted hydride groups with an alkenyl functional epoxy to provide an imide functional organopolysiloxane comprising imide and epoxy functional groups.

In one embodiment, the method further comprises (iii) reacting the imide functional siloxane having the unreacted hydride groups with an alkenyl functional aromatic and/or aliphatic group to provide the imide functional organopolysiloxane comprising imide and aromatic or aliphatic substitutions.

In one embodiment, step (ii) follows step (i).

In one embodiment, step (iii) follows step (i) which is followed by step (ii), wherein the imide functional organopolysiloxane, comprising imide and aromatic and/or aliphatic substitutions, having the unreacted hydride groups reacts with an alkenyl functional epoxy to provide a imide functional organopolysiloxane comprising imide, aromatic and/or aliphatic substitutions and epoxy functional groups.

In one embodiment of the method in accordance with any previous embodiment, the imide and the epoxy groups are introduced either in the backbone or in the pendant position of the imide functional organopolysiloxane.

In one embodiment, the imide, the epoxy, and the aromatic or aliphatic groups are introduced either in the backbone or in the pendant position of the imide functional organopolysiloxane.

In one embodiment of the method in accordance with any previous embodiment, each of the reactions under (i) and (ii) is carried out in the presence of a hydrosilylation catalyst.

In still another aspect, provided is a method of forming an imide functional organopolysiloxane comprising: adding an aliphatic or aromatic substituted dianhydride; a diamino or dianhydride functional siloxane; and an aliphatic or aromatic functional amine in a single pot reaction to produce an imide functional organopolysiloxane comprising one or more substituents.

In yet a further aspect, provided is a composite material comprising the imide functional organopolysiloxane of any of the previous embodiments.

In one embodiment, the composite material further comprises a functional polymer/resin capable of reacting with the imide functional organopolysiloxane, and a catalyst.

The following description and the drawings disclose various illustrative aspects. Some improvements and novel aspects may be expressly identified, while others may be apparent from the description and drawings.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As used herein, the term, “organic group” generically refers to acyclic, cyclic (or alicyclic), and aromatic carbon based groups which can be saturated or unsaturated, and which may be optionally substituted or interrupted with one or more atoms or functional groups, such as, for example, carboxyl, cyano, hydroxy, halo and oxy. It will be appreciated that the term can encompass monovalent, divalent, and trivalent groups, and that the appropriate type of bonding group is indicated and intended in the context of the bonding of the organic group within a given formula or structure.

As used herein, the term “acyclic organic group” means a straight chain or branched carbon based group, preferably containing from 1 to 60 carbon atoms per group, which may be saturated or unsaturated and which may be optionally substituted or interrupted with one or more atoms or functional groups, such as, for example, carboxyl, cyano, hydroxy, halo and oxy. Suitable monovalent acyclic organic groups include, for example, alkyl, alkenyl, alkynyl, hydroxyalkyl, cyanoalkyl, carboxyalkyl, alkyloxy, oxaalkyl, alkylcarbonyloxaalkylene, carboxamide and haloalkyl, such as, for example, methyl, ethyl, sec-butyl, tert-butyl, octyl, decyl, dodecyl, cetyl, stearyl, ethenyl, propenyl, butynyl, hydroxypropyl, cyanoethyl, butoxy, 2,5,8-trioxadecanyl, carboxymethyl, chloromethyl and 3,3,3-fluoropropyl.

As used herein, the term “alicyclic organic group” means a carbon based group containing one or more saturated hydrocarbon rings, preferably containing from 4 to 12 carbon atoms per ring, per group which may optionally be substituted on one or more of the rings with one or more alkyl groups, each preferably containing from 2 to 6 carbon atoms per alkyl group, halo radicals or other functional groups and which, in the case of a monovalent alicyclic organic group containing two or more rings, may be fused rings. Suitable monovalent alicyclic organic groups include, for example, cyclohexyl and cyclooctyl.

As used herein, the term “aromatic organic group” means a carbon based group containing one or more aromatic rings per group, which may, optionally, be substituted on the aromatic rings with one or more alkyl groups, each preferably containing from 2 to 6 carbon atoms per alkyl group, halo groups or other functional groups and which, in the case of a monovalent aromatic group containing two or more rings, may be fused rings. Suitable monovalent aromatic groups include, for example, phenyl, tolyl, 2,4,6-trimethylphenyl, 1,2-isopropylmethylphenyl, 1-pentalenyl, naphthyl, anthryl. As used herein, the term “aralkyl” means an aromatic derivative of an alkyl group, preferably a (C2-C6)alkyl group, wherein the alkyl portion of the aromatic derivative may, optionally, be interrupted by an oxygen atom, such as, for example, phenylethyl, phenylpropyl, 2-(1-naphthyl)ethyl, preferably phenylpropyl, phenyoxypropyl, biphenyloxypropyl.

An “imide” refers to a compound or group having at least one C(O)—N—C(O) functionality in the compound. Imides include, but are not limited to, mono-imides, bisimides substituted imide or unsubstituted imide. The imide compounds or groups can be a cyclic or acyclic compound.

Numerical values given for a range or ranges of a component can be combined to form new or non-specified ranges.

Provided is an imide functional organopolysiloxane material. The imide functional organopolysiloxane comprises a siloxane modified with an imide functional group. In further embodiment, imide functional organopolysiloxane may also contain an epoxy functional group. The imide functional group can be pendant to a siloxane unit, or the imide group may be disposed in the backbone of the material (so as to effectively link two or more siloxane units).

The present technology provides an imide functional organopolysiloxane material. In one embodiment, the imide functional organopolysiloxane material is a compound having the structural formula (I):

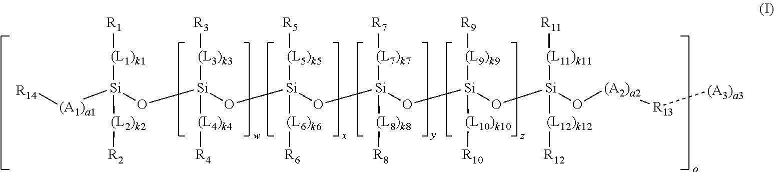

where R₁, R₂, R₃, R₄, R₅, R₆, R₇, R₈, R₉, R₁₀, R₁₁, R₁₂, R₁₃, and R₁₄ are each independently selected from hydrogen, a C1-C15 alkyl, an epoxy group, a C6-C30 aromatic containing group, and a imide group, with the provisos that (i) at least one of R₁, R₂, R₃, R₄, R₅, R₆, R₇, R₈, R₉, R₁₀, R₁₁, R₁₂, R₁₃, and R₁₄ is selected from an imide group, and (ii) at least one of R₁, R₂, R₃, R₄, R₅, R₆, R₇, R₈, R₉, R₁₀, R₁₁, R₁₂, R₁₃, and R₁₄ is selected from an epoxy group;
A₁, A₂, A₃, and L₁, L₂, L₃, L₄, L₅, L₆, L₇, L₈, L₉, L₁₀, L₁₁, and L₁₂ are linker groups each independently selected from a divalent alkyl group, a divalent alkenyl group, or a divalent ether group,
o is ≥1;
w, x, y, and z are each ≥0, where (w+x+y+z) is from 1 to 60;
k1, k2, k3, k4, k5, k6, k7, k8, k9, k10, k11, k12 are each independently ≥0; and
a1, a2, and a3 are each independently ≥0.

The C1-C15 alkyl group can be selected from linear or branched groups. In one embodiment, the C1-C15 alkyl group is selected from methyl, ethyl, propyl, isopropyl, butyl, isobutyl, tert-butyl, pentyl, isopentyl, hexyl, heptyl, octyl, and isooctyl.

The C6-C30 aromatic groups can be selected from an aryl, an arylalkyl, and an alkaryl group. The term “aryl” means any monovalent aromatic hydrocarbon group; the term “aralkyl” means any alkyl group (as defined herein) in which one or more hydrogen atoms have been substituted by the same number of like and/or different aryl (as defined herein) groups; and, the term “arylakyl” means any aryl group (as defined herein) in which one or more hydrogen atoms have been substituted by the same number of like and/or different alkyl groups (as defined herein). The aromatic group can comprise one or more aromatic rings. In a group with multiple aromatic rings, the rings can be joined by a bond, joined by a linker group (e.g., a divalent hydrocarbon group or a group with heteroatoms), or maybe a fused ring system. An aromatic radical may be an array of atoms having a valence of at least one and having at least one aromatic group. This may include heteroatoms such as nitrogen, sulfur, selenium, silicon and oxygen, or may be composed exclusively of carbon and hydrogen. Suitable aromatic radicals may include phenyl, pyridyl, furanyl, thienyl, naphthyl, phenylene, and biphenyl radicals. The aromatic group may be a cyclic structure having 4n+2 “delocalized” electrons where “n” may be an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical also may include non-aromatic components. For example, a benzyl group may be an aromatic radical, which may include a phenyl ring (the aromatic group) and a methylene group (the non-aromatic component). An aromatic radical may include one or more functional groups, such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. Examples of C6-C30 aromatic groups include, but are not limited to phenyl, naphthyl; o-, m- and p-tolyl, xylyl, ethylphenyl, and benzyl.

In one embodiment, at least one of R₁, R₂, R₃, R₄, R₅, R₆, R₇, R₈, R₉, R₁₀, R₁₁, and/or R₁₂ is selected from an imide, at least one of R₁, R₂, R₃, R₄, R₅, R₆, R₇, R₈, R₉, R₁₀, R₁₁, and/or R₁₂ is selected from an epoxy, and least one of R₁, R₂, R₃, R₄, R₅, R₆, R₇, R₈, R₉, R₁₀, R₁₁, and/or R₁₂ is selected from an C6-C30 aromatic group. In this embodiment, the residual groups of R₁, R₂, R₃, R₄, R₅, R₆, R₇, R₈, R₉, R₁₀, R₁₁, and/or R₁₂ are each independently selected from a C1-C15 alkyl group.

In one embodiment, R₁, R₂, R₃, R₄, R₅, R₇, R₉, R₁₀, R₁₁, and R₁₂ are independently selected from hydrogen, a C1-C15 alkyl group, and a C6-C30 aromatic, R₁₃ is selected from an imide functional group, and R₁₄ is selected from an epoxy functional group.

In one embodiment, R₁, R₂, R₃, R₄, R₅, R₆, R₇, R₈, R₉, R₁₀, R₁₁, and/or R₁₂ are each independently selected from hydrogen and a C1-C15 alkyl group, and R₁₃ and R₁₄ are selected from a substituted or non-substituted bisimide.

The epoxy group is not particularly limited and can be selected as desired for a particular purpose or intended application. In one embodiment, the epoxy group is selected from a glycidyl group or a glycidyl ether group. The epoxy group can be of the formula (II) or (III):

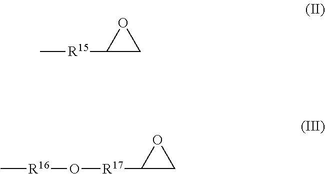

where R¹⁵, R¹⁶, and R¹⁷ are each independently selected from a C1-C10 divalent hydrocarbon group.

The imide group can be selected from a group comprising an imide functionality. In embodiments, the imide functionality is selected from a group of the formulas (IV), (V), and (VI):

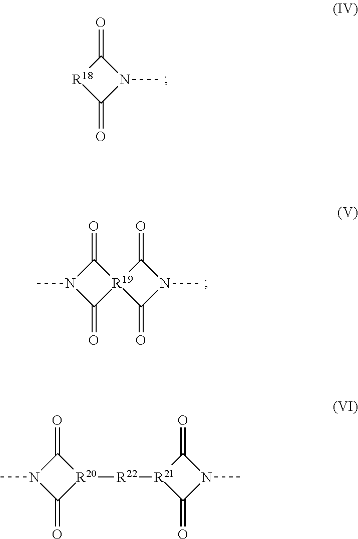

where R¹⁸, R¹⁹, R²⁰, and R²¹ are independently selected from a C2 to C30 divalent organic group, and R²² is selected from a bond, a C1-C30 divalent organic group, or an O atom. The C2 to C30 divalent group can be saturated, unsaturated, linear, branched, cyclic, an aromatic group or the like, and may be unsubstituted or substituted.

In one embodiment, R¹⁸, R²⁰, and R²¹ are each independently selected from a C2 to C30 divalent chain so as to form a single ring. In one embodiment, R¹⁸, R²⁰, and R²¹ are independently selected from a C2 to C6 divalent chain. In one embodiment, R¹⁸, R²⁰, and R²¹ are independently selected from a C2 or C3 divalent group to provide a five or six membered imide ring.

In one embodiment, R¹⁹ is a C5-C30 cyclic containing hydrocarbon. In one embodiment, the cyclic containing hydrocarbon can be an unsaturated ring, a saturated ring, a fused ring system that may be saturated or unsaturated, or a multiple ring system that is separated by a bond or other linker group. The rings may be, in embodiments, aromatic rings.

In one embodiment, R¹⁸, R²⁰, and R²¹ are each independently selected from a C5-C30 cyclic containing hydrocarbon. In one embodiment, the cyclic containing hydrocarbon can be an unsaturated ring, a saturated ring, a fused ring system that may be saturated or unsaturated, or a multiple ring system that is separated by a bond or other linker group. The rings may be, in embodiments, aromatic rings.

Some non-limiting examples of R18 include:

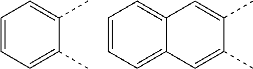

Non-limiting examples of R19 include:

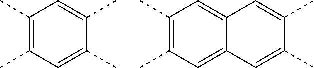

Non-limiting examples of R20 and R21 include:

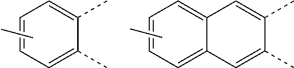

R²² is selected from a bond, a C1 to C30 divalent organic group, or an O atom. The divalent organic group can be linear, branched, or contain one or more cyclic groups including, for example, C6 to C30 aromatic groups. The C1 to C30 divalent organic group can be unsubstituted or substituted. Substituted organic groups may include, for example, one or more heteroatoms selected from N, O, S, and/or a halo group (e.g., F). In one embodiment, R²² is selected from a divalent C1-C10 group. In one embodiment, R²² is selected from —CH₂—, —CH₂CH₂—, or —CH₂CH₂CH₂—. In one embodiment, R²² is selected from a —O— linkage. In one embodiment, R²² is selected from a C1-C10 group optionally containing at least one C—O—C linkage. In one embodiment, R²² is selected from a divalent C1-C10 group wherein one or more hydrogens are replaced with a fluorine atom. In one embodiment, R²² is selected from a —(CF₂)n- where n is 1 to 10. In one embodiment, R²² is selected from a (—C(CF₃)(CF₃)—)m, where m is 1 to 10.

Some examples of suitable imide groups include, but are not limited to:

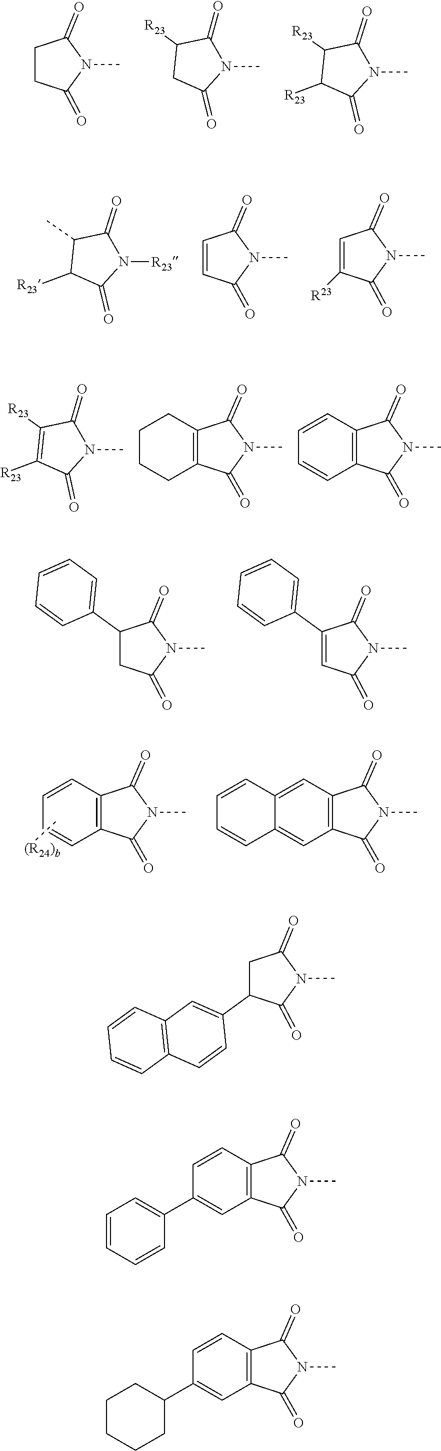

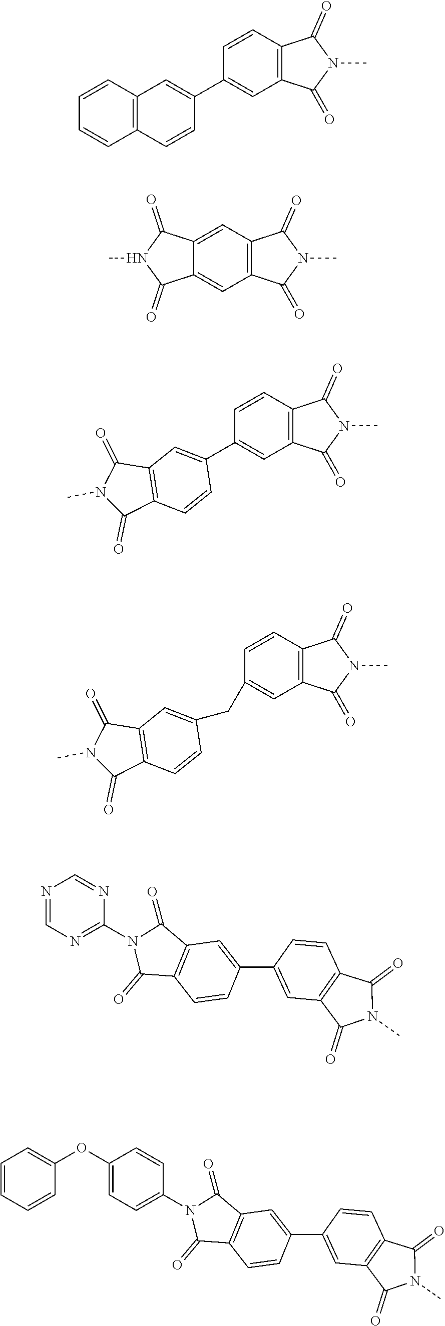

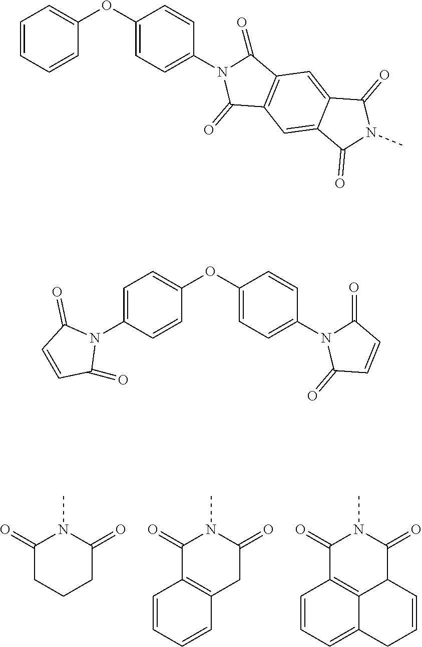

where R²³ and R²⁴ may be selected from hydrogen, a C1-C15 alkyl, an epoxy group, a C4 to C20 cyclic group, a C6-C30 aromatic containing group, which may be substituted or unsubstituted, and where the carbon atoms in the cyclic or aromatic group can be replaced by a heteroatom selected from O, N, or S. b is an integer of 0 to 4. R^{23′} is a divalent organic group containing glycidoxy and imide substitutions, and R^{23″} is an amino terminal siloxane.

In one embodiment, R¹ through R¹² are independently selected from hydrogen, an epoxy group, a C1-C15 alkyl, a C6-C30 aromatic group, and an imide group, and R¹³ and R¹⁴ are selected from a C1-C15 alkyl, where at least one of R¹ through R¹² is selected from an imide, and at least one of R¹ through R¹² is selected from an epoxy. In one embodiment, R¹, R², R³, R⁴, R⁵, R⁷, R⁹, R¹⁰, R¹¹, and R¹² are independently selected from hydrogen, a C1-C15 alkyl, and a C6-C30 aromatic, R⁶ is selected from an imide functional group, and R⁸ is selected from an epoxy functional group. In an exemplary embodiment, the imide functional organopolysiloxane comprises an imide functional group, an epoxy functional group, an alkenyl aryl group in the pendant position, as shown in Structure A:

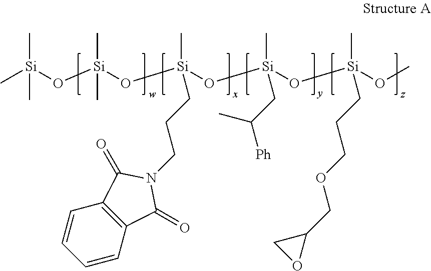

In one embodiment, R₁ through R₁₂ are independently selected from hydrogen or a C1-C15 alkyl, and R₁₃ and R₁₄ are independently selected from an imide containing group. In an exemplary embodiment, the imide functional organopolysiloxane is a linear molecule comprising an imide functional group connected to siloxane backbone with terminal epoxy functional groups, as shown in, Structure B:

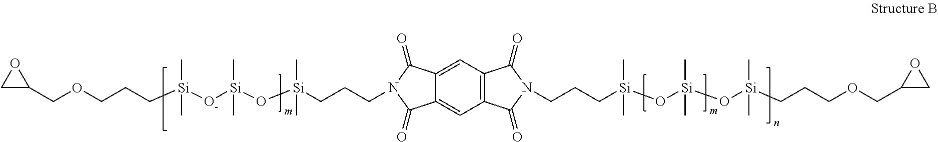

In an exemplary embodiment, the imide functional organopolysiloxane comprises triazene substituted bisimide functional groups as shown in Structure C:

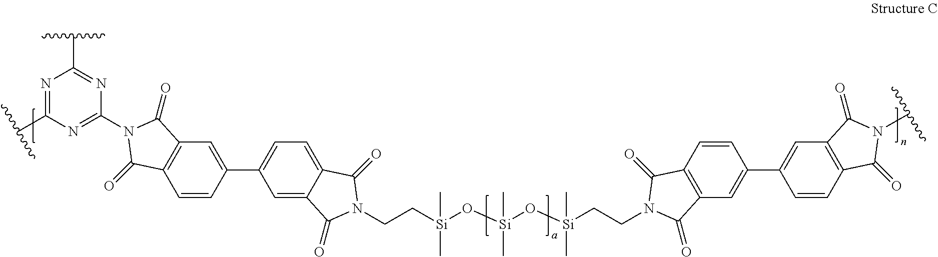

In another exemplary embodiment, the imide functional organopolysiloxane comprises diphenyl ether substituted bisimide functional groups wherein the R¹⁹ is a benzene ring as shown in, Structure D:

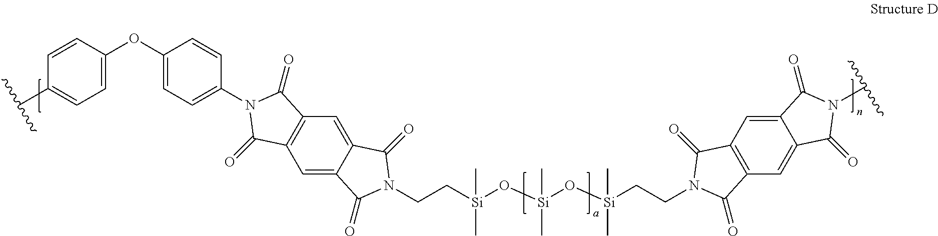

In another exemplary embodiment, the imide functional organopolysiloxane comprises diphenyl ether substituted bisimide functional groups wherein the R¹⁹ is multiple ring system, such as biphenyl as shown in, Structure E:

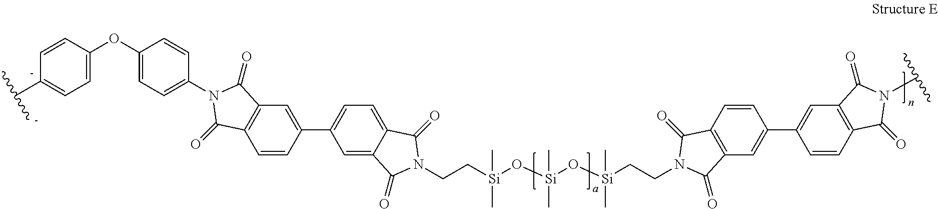

In another exemplary embodiment, the imide functional organopolysiloxane comprises multiple imide and substituted bisimide functional groups, wherein the R₁₄ is bisimide substituted organopolysiloxane (Structure (I)) and R₁₃ is imide substituted organopolysiloxane (Structure (I)), and R₁₄ and R₁₃ are connected through ethylene linkers (A1 and A2) to the siloxane backbone as shown in, Structure F:

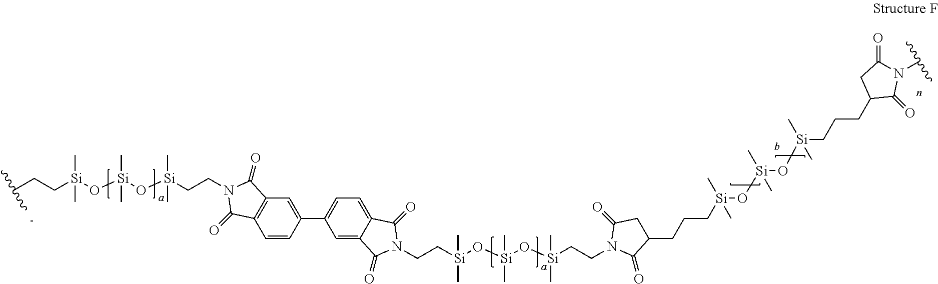

In another exemplary embodiment, the imide functional organopolysiloxane comprises siloxane backbone with two linkers at two ends, including a linker (A₁) of substituted divalent alkyl, such as amino alkyl at one end and a linker (A₂) of amino alkyl at another end with a substitution of —CH(OH)—CH2-O—CH2-, and wherein the R¹³ is substituted imide, wherein the substituted imide containing R^{23′} which is a divalent organic group containing glycidoxy and imide substitutions, and the substituted imide also contains R^{23″} which is an amino terminal siloxane as shown in Structure G:

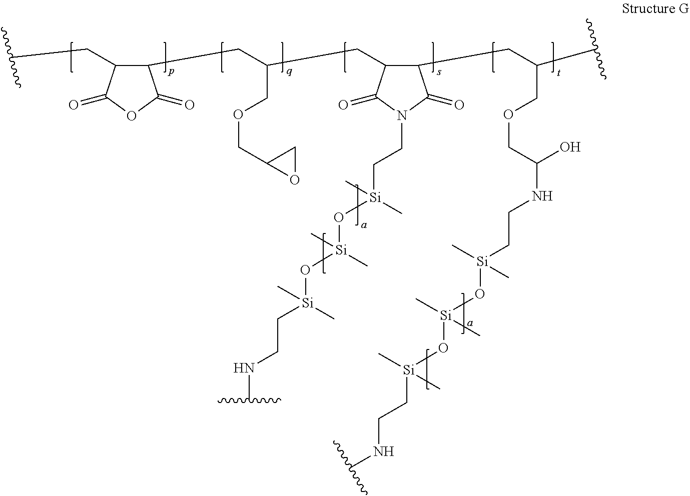

In another exemplary embodiment, the imide functional organopolysiloxane comprises multiple imide and substituted bisimide functional groups, wherein the R₁₄ is bisimide substituted organopolysiloxane (Structure (I)) and R13 is imide substituted organopolysiloxane (Structure (I)), and R₁₄ and R₁₃ are connected through ethylene linkers (A1 and A2) to the siloxane backbone as shown in Structure H:

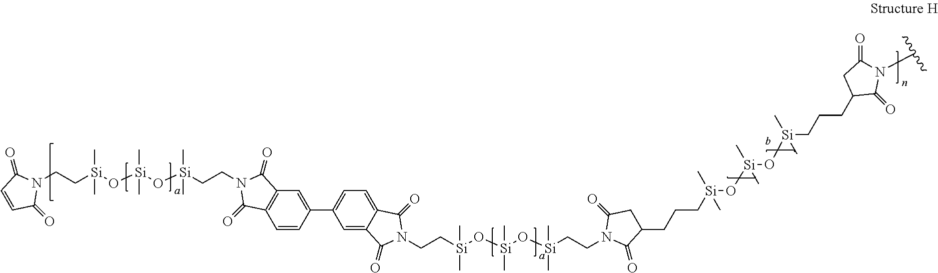

In another exemplary embodiment, the imide functional organopolysiloxane comprises multiple imide and substituted bisimide functional groups, wherein the R₁₄ is bisimide substituted organopolysiloxane (Structure (I)) and R₁₃ is imide substituted organopolysiloxane (Structure (I)), and R₁₄ and R₁₃ are connected through ethylene linkers (A1 and A2) to the siloxane backbone, and R²² is —C(CF₃)₂ as shown in, Structure J:

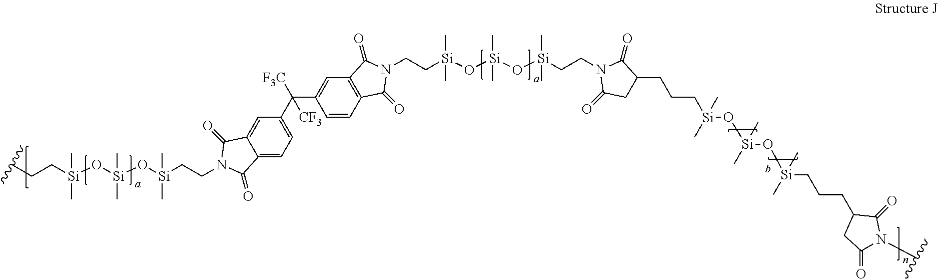

In another exemplary embodiment, the imide functional organopolysiloxane comprises multiple imide and triazine substituted bisimide functional groups, wherein the R₁₄ is triazine substituted bisimide (Structure (I)) and R₁₃ is imide substituted organopolysiloxane (Structure (I)), and R₁₄ and R₁₃ are connected through ethylene linkers (A1 and A2) to the siloxane backbone, and R²² is —C(CF₃)₂ as shown in, Structure K:

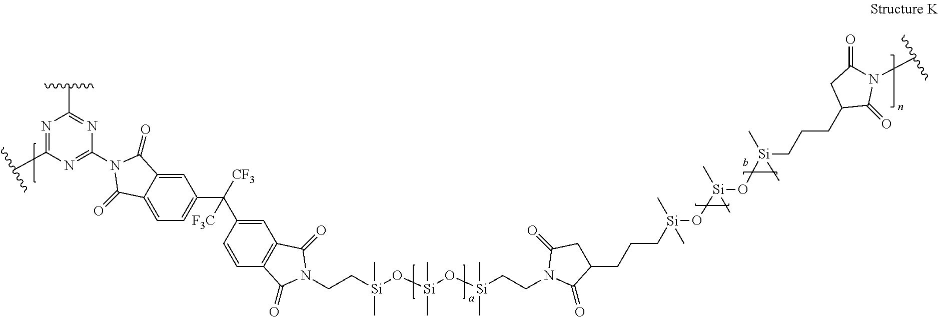

Structures A-K illustrate examples of embodiments of imide functional organopolysiloxanes in accordance with aspects of the present technology as described above.

In one embodiment, compounds in accordance with the present technology can be prepared by introducing the imide groups and the epoxy groups to a siloxane unit via hydrosilylation reaction. In one embodiment, an alkenyl functional imide is reacted with a hydride functional siloxane to provide an imide functional siloxane. The reaction can be controlled such that there is a molar excess of hydride functional groups after reaction with the imide such that imide functional siloxane comprises hydride functional moieties. The imide functional siloxane comprising hydride functional groups is then reacted with an alkenyl functional epoxy to yield the imide functional organopolysiloxane.

The reaction can be conducted in a solvent. Solvent may be needed, for example, to dissolve the alkenyl functional imides. The reaction can also be conducted at elevated temperatures. In embodiments, the reaction for both the addition of the imide and the addition of the epoxy group can be conducted at temperatures of from about 50° C. to about 110° C., from about 60° C. to about 100° C., or from about 75° C. to about 90° C.

The alkenyl functional imide can be, for example selected from a compound of the formula.

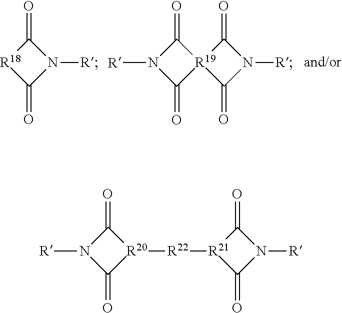

where R⁸, R¹⁹, R²⁰, R²¹, and R²² are as described above, and R′ is independently selected from a C2-C30 alkenyl functional group. Generally, the alkenyl functional group comprises a terminal alkenyl group. In embodiments, R′ is selected from a vinyl, allyl, methallyl, butenyl, isobutenyl, sec-butenyl, pentenyl, hexenyl, heptenyl, ocetenyl, nonenyl, or decenyl functional group as well as branched groups of 6 or more carbon atoms.

A hydrosilylation catalyst is employed for each of the reactions. The catalyst employed in the reaction of the alkenyl functional imide may also be employed in the reaction of the alkenyl functional epoxy with the imide functionalized siloxane. The hydrosilylation catalyst is not particularly limited, and any suitable hydrosilylation catalyst can be employed in the reaction. In one embodiment, the catalyst is selected from a hydrosilylation catalyst based on a platinum-group metal. For the purposes of the present invention, the expression “platinum-group metals” means the metals ruthenium, rhodium, palladium, osmium, iridium, and platinum. In one embodiment, the hydrosilylation catalyst is based on platinum. Hydrosilylation catalysts that are further preferred are platinum-alkenylsiloxane complexes. Preference is in particular given to a hydrosilylation catalyst selected from the group consisting of platinum-1,3-divinyl-1,1,3,3-tetramethyldisiloxane complex (Karstedt complex), platinum-1,3-diallyl-1,1,3,3-tetramethyl-disiloxane complex, platinum-1,3-divinyl-1,3-dimethyl-1,3-diphenyldisiloxane complex, platinum-1,1,3,3-tetraphenyldisiloxane complex and platinum-1,3,5,7-tetramethyl-1,3,5,7-tetravinylcyclotetrasiloxane complex. More preferably, the hydrosilylation catalyst is platinum-1,3-divinyl-1,1,3,3-tetramethyldisiloxane complex (Karstedt complex).

In an alternative embodiment, an alkenyl functional siloxane can be employed with a hydride functional imide to provide an imide functional siloxane. The reaction can be controlled such that there is a molar excess of alkenyl functional groups after reaction with the imide such that imide functional siloxane comprises alkenyl functional moieties. The imide functional siloxane comprising alkenyl functional moieties is then reacted with a hydride functional epoxy to yield the imide functional organopolysiloxane.

In another embodiment, imide functionalized organopolysiloxanes in accordance with the present technology can be prepared by an imidization reaction. The imidization reaction comprises adding an aliphatic or aromatic substituted dianhydride; a diamino or dianhydride functional siloxane; and an aliphatic or aromatic functional amine to produce an imide functional siloxane comprising one or more substituents. The imidization reaction comprises reacting a diamino siloxane with a dianhydride and optionally a functional amino organic group and/or an anhydride and heating the mixture. The reaction can be conducted as a “one pot” reaction. In embodiments, the reaction can be conducted at a temperature of from about 100° C. to about 200° C., of from about 120° C. to about 180° C., from about 130° C. to about 170° C., or from about 150° C. to about 160° C.

The diamino siloxane is a siloxane of a desired chain length having terminal amino groups.

The dianhydride can be selected to provide an imide of a desired structure. In embodiments, the dianhydride is selected from a compound of the formulas:

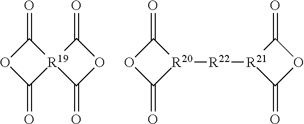

where R¹⁹, R²⁰, R²¹, and R²² are as described above.

The functional amine may comprise the organic group including, but is not limited to, aliphatic, cyclic, acyclic, alicyclic, heterocyclic, aromatic, and heteroaromatic. In some embodiments, the functional amine includes, but is not limited to, mono amines, di-amines, tri-amines. In such embodiments, each of these amines may be a primary amine, a secondary amines or a tertiary amine.

The imidization reaction can optionally employ an anhydride terminated siloxane where the anhydride terminated siloxane is obtained by hydrosilylation reaction of an alkenyl functional anhydride with hydride functional siloxane. The alkenyl functional anhydride can be of the formula:

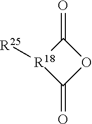

where R¹⁸ is as described above, and R²⁵ is an alkenyl functional group. The alkenyl functional group can be selected from a C2-C30 alkenyl functional group. Examples of R²⁵ include, but are not limited to, vinyl, allyl, methallyl, butenyl, isobutenyl, sec-butenyl, pentenyl, hexenyl, heptenyl, ocetenyl, nonenyl, or decenyl functional group as well as branched groups of 6 or more carbon atoms.

The imide functional organopolysiloxane can be used to form a composite material. Composite materials comprising imide functional organopolysiloxanes possess attributes such as thermal stability, high curability, and/or low thermal expansion. In one embodiment, a composite material comprises the imide functional organopolysiloxane, a functional polymer/resin capable of reacting with the imide functional organopolysiloxane, a catalyst, and optional additives such as, but is not limited to, a filler, a plasticizer, and the like.

Examples of suitable polymers capable of reacting with the imide functional organopolysiloxane include, but are not limited to, active polymers include but are not limited to: ethylenically unsaturated monomers and prepolymers, vinyl functional monomers and prepolymers, hydride functional monomers and prepolymers, hydroxyl functional monomers and pre-polymers, epoxy functional monomers and pre-polymers, amino-functional monomers and pre-polymers, derivatives of (meth)acrylic acid and its esters, polyurethanes, polyethers, polyesters, polylactones, polylactides, polyglycolides, polyacids, polyamides, polyethylene, polypropylene, poly(alkene oxides) such as polyethylene oxide, polypropylene oxide, polybutadiene, polybutylene, polyacrylonitrile, polyvinyl chloride, polystyrene, polysulfone, PEEK, polycarbonate, polyepoxides, fluoropolymers such as PTFE, polyvinyldifluoride, synthetic and natural rubber, phenol formaldehyde, melamine formaldehyde, urea formaldehyde, polymers of natural or semisynthetic origin such as polysaccharides, cellulose, proteins, polypeptides, poly(amino acids), organosilicon polymers such as but not limited to polysiloxanes, polysilicates, polysilsesquioxanes, polysilanes, ionically modified versions of the above, and various isomers and co-polymers of the above polymers.

The present technology has been described in the foregoing detailed description and with reference to various aspects and embodiments. The technology may be further understood with reference to the following Examples. The Examples are intended to further illustrate aspects and embodiments of the present technology and not necessarily to be limited to such aspects or embodiments.

### EXAMPLES

Example 1: Synthesis of organopolysiloxane with pendant groups, Structure A with average chemical formula where w=44, x=1, y=5, & z=5. (1) A pendant hydride siloxane, MD₄₄D′₁₁M (150 g), 2-allylisoindoline-1,3-dione (7.4 g), and methylbenzene (150 mL) were charged into an appropriate size three necked round bottomed flask fitted with a thermopocket, a condenser, and a dropping funnel. The temperature of the reaction mixture was raised to 93° C. before adding 10 ppm of platinum catalyst to the reaction mixture. (2) After the completion of step 1, α-methyl styrene (25.69 g) was taken into the dropping funnel and was added dropwise to the reaction mixture. The internal temperature of the reaction mixture was raised to 96.5° C. after complete addition of α-methyl styrene and stabilization of the exotherm. (3) After the completion of step 2, allyl glycidyl ether (33.9 g) was taken into the dropping funnel and added dropwise to the reaction mixture. After the completion of the reaction, charcoal treatment of the mixture was performed to remove the colloidal Pt, while stirring the mixture for 4 hours at 50° C. The treated material was filtered and separated from the charcoal by using a sintered funnel with a celite bed, and the filtrate was collected. Then the solvent was removed from the filtrate to obtain the product as a yellow-coloured viscous product as shown as Structure A. M_{w} of the product was confirmed to be 12714 gmol⁻¹ with polydispersity index (PDI) of 2.1 from gel permeation chromatography (GPC).

Example 2: Synthesis of organopolysiloxane with pendant groups, Structure A, with average chemical formula where w=11, x=0.5, y=1.8, & z=1.7. (1) A pendant hydride siloxane, MD₁₁D′₄M (150 g), 2-allylisoindoline-1,3-dione (8.52 g), and methylbenzene (50 mL) were charged into an appropriate size three necked round bottomed flask fitted with a thermopocket and condenser, and a dropping funnel. The temperature of the reaction mixture was raised to 90° C. before adding 10 ppm of platinum catalyst to the reaction mixture. (2) After the completion of step 1, α-methyl styrene (28.77 g) was taken in the dropping funnel and added dropwise to the reaction mixture. After complete addition of α-methyl styrene, the temperature of the reaction mixture was raised to 95° C. (3) After the completion of step 2, allyl glycidyl ether (37.91 g) was taken in the dropping funnel and added dropwise to the reaction mixture. After the completion of the reaction, charcoal treatment of the mixture was performed to remove the colloidal Pt, while stirring the mixture for 4 hours at 50° C. The treated material was filtered and separated from charcoal, by using a sintered funnel with a celite bed, and the filtrate was collected. The solvent was then removed from the filtrate to obtain a yellow-coloured viscous product as shown in Structure A. M_{W} of the product was confirmed to be 4823 gmol⁻¹ with PDI of 2.5 from GPC.

Example 3: Synthesis of organopolysiloxane, Structure B, N,N-diallyl pyromellitic diimide (20 g) was taken in a round bottom flask equipped with a thermometer, condenser, and dropping funnel. Methylbenzene was added to dissolve the diimide. Then, the temperature of the mixture was raised to 75° C., followed by addition of telechelic hydride siloxane, M′D₁₂M′ (150 g) into the RBF. Then, 10 ppm of Platinum catalyst was added to the reaction mixture and an exotherm was observed during the addition of hydride. After the stirring the mixture for 2 hours, proton NMR was recorded. Upon consumption of the N,N-diallyl pyromellitic diimide, further endcapping of imide modified siloxane hydride was done with allyl glycidyl ether (25 g). The reaction mixture was allowed to stir for completion at 75° C. Then, proton NMR was recorded to check for complete consumption of hydride. After the completion of the reaction, the charcoal treatment of the mixture was done to remove the colloidal Pt, while stirring the mixture for 4 hours at 50° C. The treated material was filtered and separated from charcoal, by using sintered funnel with celite bed, and the filtrate was collected. The solvent was then removed from the filtrate to obtain the light yellow-colored viscous material, as shown in Structure B. M_{W} of the product was confirmed to be 5798 gmol⁻¹ with PDI of 1.9 from GPC.

Example 4: Synthesis of organopolysiloxane, Structure B, N,N-diallyl pyromellitic diimide (51.82 g) was taken in a round bottom flask equipped with a thermometer, condenser, and dropping funnel. Methylbenzene was added to dissolve the diimide. Then, the temperature of the mixture was raised to 75° C., followed by addition of telechelic hydride siloxane, M′D₉M′ (200 g) into the RBF. Then, 10 ppm of Platinum catalyst was added to the reaction mixture and an exotherm was observed during the addition of hydride. After the stirring the mixture for 2 hours, proton NMR was recorded. Upon consumption of the N,N-diallyl pyromellitic diimide, further endcapping of imide modified siloxane hydride was done with allyl glycidyl ether (18 g). The reaction mixture was allowed to stir for completion at 75° C. Then, proton NMR was recorded to check for complete consumption of hydride. After the completion of the reaction, the charcoal treatment of the mixture was done to remove the colloidal Pt, while stirring the mixture for 4 hours at 50° C. The treated material was filtered and separated from charcoal, by using sintered funnel with celite bed, and the filtrate was collected. The solvent was then removed from the filtrate to obtain the light yellow-coloured viscous material, as shown in Structure B. M_{W} of the product was confirmed to be 8802 gmol⁻¹ with PDI of 2.9 from GPC.

Example 5: Synthesis of organopolysiloxane, Structure D Amino terminated siloxane, NH₂MD₁₀MNH₂ (174 g), 4,4′-diaminodiphenyl ether (15 g) and pyromellitic dianhydride (66 g) was taken in a round bottom flask equipped with a thermometer and condenser. Dimethylacetamide (476 g) and gamma-butyrolactone (119 g) was added to dissolve them. Then pyridine (0.8 g) was added to the mixture. The temperature of the mixture was raised to 160° C. and the mixture was stirred at 160° C. for 3 hours. After the mixture was cooled down to 25° C., mixture of methanol (680 g) and water (170 g) was added. Brown powder was precipitated and filtered to obtain the product of organopolysiloxane as shown in Structure D. M_{W} of the product was confirmed to be 8650 gmol⁻¹ with PDI of 2.46 from GPC and 50% of imidization ratio was confirmed with FT-IR by calculating peak Abs. (Abs. 1720 cm⁻¹/(Abs.1720 cm⁻¹+Abs.3300 cm⁻¹)).

Example 6: Synthesis of organopolysiloxane, Structure E Amino terminated siloxane, NH₂MD₁₀MNH₂ (191 g), 4,4′-diaminodiphenyl ether (7 g) and 4,4′-biphthalic anhydride (83 g) was taken in a round bottom flask equipped with a thermometer and condenser. Dimethylacetamide (526 g) and gamma-butyrolactone (131 g) was added to dissolve them. Then triethylamine (1.1 g) was added to the mixture. The temperature of the mixture was raised to 160° C. and the mixture was stirred at 160° C. for 3 hours. After the mixture was cooled down to 25° C., methanol (1881 g) was added. Brown viscous liquid was separated at the bottom of RBF and supernatant was removed. Residual solvent in brown viscous liquid was removed by vacuum to obtain the product, organopolysiloxane as shown in Structure E. M_{W} of the product was confirmed to be 6050 gmol⁻¹ with PDI of 1.97 from GPC and 60% of imidization ratio was confirmed with FT-IR by calculating peak Abs. (Abs.1720 cm⁻¹/(Abs.1720 cm⁻¹+Abs.3300 cm⁻¹)).

Example 7: Synthesis of organopolysiloxane, Structure F, Amino terminated siloxane, NH₂₁MD₁₀MNH₂ (174 g), 4,4′-biphthalic anhydride (47 g) and allyl 3-propyl succinic anhydride terminated siloxane, ^{ASA}MD₁₀M^{ASA} (71 g) was taken in a round bottom flask equipped with a thermometer and condenser. Dimethylacetamide (545 g) and gamma-butyrolactone (136 g) was added to dissolve them. Then imidazole (0.7 g) was added to the mixture. The temperature of the mixture was raised to 160° C. and the mixture was stirred at 160° C. for 3 hours. After the mixture was cooled down to 25° C., mixture of methanol (779 g) and water (194 g) was added. Brown viscous liquid was separated at the bottom of RBF and supernatant was removed. Residual solvent in brown viscous liquid was removed by vacuo to obtain the product, organopolysiloxane as shown in Structure F. Mw of the product was confirmed to be 5000 gmol⁻¹ with PDI of 1.64 from GPC and 80% of imidization ratio was confirmed with FT-IR by calculating peak Abs. (Abs.1720 cm⁻¹/(Abs.1720 cm⁻¹+Abs.3300 cm⁻¹)).

Example 8: Synthesis of organopolysiloxane, Structure H, Amino terminated siloxane, NH₂₁MD₁₀MNH₂ (174 g), 4,4′-biphthalic anhydride (35 g) and allyl 3-propyl succinic anhydride terminated siloxane, ^{ASA}MD₁₀M^{ASA} (59 g) was taken in a round bottom flask equipped with a thermometer and condenser. Dimethylacetamide (519 g) and gamma-butyrolactone (130 g) was added to dissolve them. Then imidazole (0.7 g) was added to the mixture. The temperature of the mixture was raised to 160° C. and the mixture was stirred at 160° C. for 3 hours. The reaction mixture was cooled down to 25° C. and maleic anhydride (10 g) was added. The temperature of the mixture was raised to 160° C. and the mixture was stirred at 160° C. for 3 hours. After the mixture was cooled down to 25° C., mixture of methanol (741 g) and water (185 g) was added. Brown viscous liquid was separated at the bottom of RBF and supernatant was removed. Residual solvent in brown viscous liquid was removed by vacuum to obtain the product, organopolysiloxane as shown in Structure H. M_{W} of the product was confirmed to be 4800 gmol⁻¹ with PDI of 1.71 from GPC and 80% of imidization ratio was confirmed with FT-IR.

Example 9: Synthesis of organopolysiloxane, Structure J, Amino terminated siloxane, NH₂MD₁₀MNH₂ (174 g), 4,4′-(hexafluoroisopropylidene) diphthalic anhydride (91 g) and allyl 3-propyl succinic anhydride terminated siloxane, ^{ASA}MD₁₀M^{ASA} (18 g) was taken in a round bottom flask equipped with a thermometer and condenser. Dimethylacetamide (528 g) and gamma-butyrolactone (132 g) was added to dissolve them. Then imidazole (0.7 g) was added to the mixture. The temperature of the mixture was raised to 160° C. and the mixture was stirred at 160° C. for 3 hours. After the mixture was cooled down to 25° C., mixture of methanol (755 g) and water (189 g) was added. Brown viscous liquid was separated at the bottom of RBF and supernatant was removed. Residual solvent in brown viscous liquid was removed by vacuo to obtain the product, organopolysiloxane as shown in Structure J. M_{W} of the product was confirmed to be 6250 gmol⁻¹ with PDI of 2.1 from GPC and 90% of imidization ratio was confirmed with FT-IR.

Example 10: Synthesis of organopolysiloxane, Structure K, Amino terminated siloxane, NH₂MD₁₀MNH₂ (174 g), melamine monomer (4 g), 4,4′-(hexafluoroisopropylidene) diphthalic anhydride (99 g) and allyl 3-propyl succinic anhydride terminated siloxane, ^{ASA}MD₁₀M^{ASA} (49 g) was taken in a round bottom flask equipped with a thermometer and condenser. Dimethylacetamide (608 g) and gamma-butyrolactone (152 g) was added to dissolve them. Then imidazole (0.7 g) was added to the mixture. The temperature of the mixture was raised to 160° C. and the mixture was stirred at 160° C. for 3 hours. After the mixture was cooled down to 25° C., mixture of methanol (815 g) and water (272 g) was added. Yellow viscous liquid was separated at the bottom of RBF and supernatant was removed. Residual solvent in yellow viscous liquid was removed by vacuo to obtain the product, organopolysiloxane as shown in Structure K. M_{W} of the product was confirmed to be 5500 gmol⁻¹ with PDI of 2.1 from GPC and 90% of imidization ratio was confirmed with FT-IR.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The siloxanes of the present invention having imide, epoxy, aliphatic, aromatic groups were found to have excellent attributes such as thermal stability, low thermal expansion when used in a composite formulation. Additionally, the siloxanes of the present invention allow us to prepare compositions having low retention of moisture and would result in cured articles having high mechanical strength.

The foregoing description identifies various, non-limiting embodiments of organopolysiloxane. Modifications may occur to those skilled in the art and to those who may make and use the invention. The disclosed embodiments are merely for illustrative purposes and not intended to limit the scope of the invention or the subject matter set forth in the claims.

What is claimed is:

1. A siloxane comprising an imide functional group, and at least one functional group selected from an epoxy, a hydride, an aromatic, an aliphatic, an amine, and/or an acryl or acryloxy, where the siloxane is selected from a linear siloxane and a non-linear siloxane, wherein the non-linear siloxane comprises at least two of said functional groups selected from an epoxy, a hydride, an aromatic, an aliphatic, an amine, and/or an acryl or acryloxy.

2. The siloxane of claim 1, wherein the siloxane is according to formula (I) 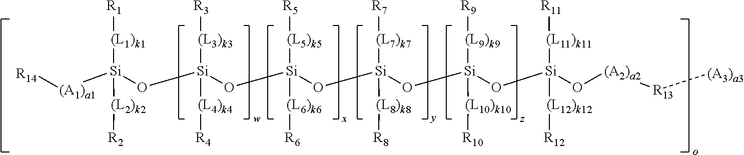
where R₁, R₂, R₃, R₄, R₅, R₆, R₇, R₈, R₉, R₁₀, R₁₁, R₁₂, R₁₃, and R₁₄ are each independently selected from hydrogen, a C1-C15 alkyl, an epoxy group, a C6-C30 aromatic containing group, and a imide group, with the provisos that (i) at least one of R¹, R², R³, R⁴, R⁵, R⁶, R⁷, R⁸, R⁹, R¹⁰, R¹¹, R¹², R¹³, and R¹⁴ is selected from an imide group, and (ii) at least one of R¹, R², R³, R⁴, R⁵, R⁶, R⁷, R⁸, R⁹, R¹⁰, R¹¹, R¹², R¹³, and R¹⁴ is selected from an epoxy group;
A₁, A₂, A₃, and L₁, L₂, L₃, L₄, L₅, L₆, L₇, L₈, L₉, L₁₀, L₁₁, and L₁₂ are linker groups each independently selected from a divalent alkyl group, a divalent alkenyl group, and a divalent ether groups;
o is ≥1;
w, x, y, and z are each ≥0, where (w+x+y+z) is from 1 to 60;
k1, k2, k3, k4, k5, k6, k7, k8, k9, k10, k11, k12 are each independently ≥0; and
a1, a2, and a3 are each independently ≥0.

3. The siloxane of claim 2, wherein at least one of R₁, R₂, R₃, R₄, R₅, R₆, R₇, R₈, R₉, R₁₀, R₁₁, and/or R₁₂ is selected from an imide, at least one of R₁, R₂, R₃, R₄, R₅, R₆, R₇, R₈, R₉, R₁₀, R₁₁, and/or R₁₂ is selected from an epoxy, and least one of R₁, R₂, R₃, R₄, R₅, R₆, R₇, R₈, R₉, R₁₀, R₁₁, and/or R₁₂ is selected from an C6-C30 aromatic group.

4. The siloxane of claim 2, wherein R₁, R₂, R₃, R₄, R₅, R₇, R₉, R₁₀, R₁₁, and R₁₂ are independently selected from hydrogen, a C1-C15 alkyl group, and a C6-C30 aromatic, R¹³ is selected from an imide functional group, and R₁₄ is selected from an epoxy functional group.

5. The siloxane of claim 2, wherein R₁, R₂, R₃, R₄, R₅, R₆, R₇, R₈, R₉, R₁₀, R₁₁, and/or R₁₂ are each independently selected from hydrogen and a C1-C15 alkyl group, and R¹³ and R₁₄ are selected from a substituted or non-substituted bisimide.

6. The siloxane of claim 2, wherein the imide group is selected from a group of the formulas (IV), (V), and (VI): 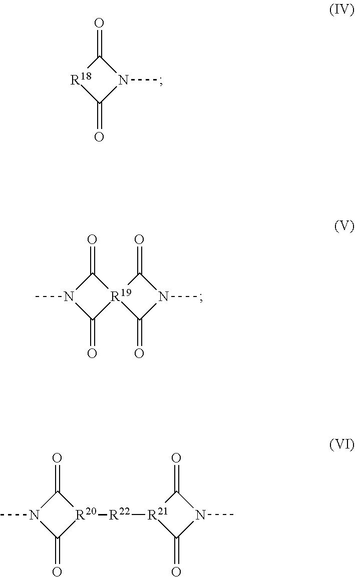
R¹⁸, R¹⁹, R²⁰, and R²¹ are independently selected from a C2 to C30 divalent organic group, and R²² is selected from a bond, a C1-C30 divalent organic group, or an O atom.

7. A method of forming an imide functional organopolysiloxane comprising:
(i) reacting an alkenyl functional imide with a hydride functional siloxane to produce an imide functional siloxane, where the imide functional siloxane contains unreacted hydride groups, and
(ii) reacting the imide functional siloxane having the unreacted hydride groups with an alkenyl functional epoxy to provide an imide functional organopolysiloxane comprising imide and epoxy functional groups.

8. The method of claim 7, further comprising (iii) reacting the imide functional siloxane having the unreacted hydride groups with an alkenyl functional aromatic and/or aliphatic group to provide the imide functional organopolysiloxane comprising imide and aromatic or aliphatic substitutions.

9. The method of claim 7, wherein the step (ii) follows step (i).

10. The method of claim 8, wherein the step (iii) follows step (i) which is followed by step (ii), wherein the imide functional organopolysiloxane, comprising imide and aromatic and/or aliphatic substitutions, having the unreacted hydride groups reacts with an alkenyl functional epoxy to provide a imide functional organopolysiloxane comprising imide, aromatic and/or aliphatic substitutions and epoxy functional groups.

11. The method of claim 7, wherein the imide and the epoxy groups are introduced either in the backbone or in the pendant position of the imide functional organopolysiloxane.

12. The method of claim 10, wherein the imide, the epoxy, and the aromatic or aliphatic groups are introduced either in the backbone or in the pendant position of the imide functional organopolysiloxane.

13. The method of claim 7, wherein each of the reactions under (i) and (ii) is carried out in the presence of a hydrosilylation catalyst.

14. A method of forming an imide functional organopolysiloxane comprising:
adding an aliphatic or aromatic substituted dianhydride; a diamino or dianhydride functional siloxane; and an aliphatic or aromatic functional amine in a single pot reaction to produce an imide functional organopolysiloxane comprising one or more substituents.

15. A composite material comprising the imide functional organopolysiloxane of claim 1.

16. The composite material of claim 15 further comprising a functional polymer/resin capable of reacting with the imide functional organopolysiloxane, and a catalyst.
